(19) United States
(12) Patent Application Publication
(10) Pub. No.: US 2020/0214301 A1
(43) Pub. Date: Jul. 9, 2020

(54) WELL-TOLERATED FLOUR COMPOSITION

(71) Applicant: Ernst Böcker GmbH & Co. KG, Minden (DE)

(72) Inventors: Georg Böcker, Minden (DE); Markus Brandt, Minden (DE); Markus Düsterberg, Minden (DE); Detlef Schuppan, Mainz (DE)

(21) Appl. No.: 16/647,856

(22) PCT Filed: Sep. 27, 2018
(86) PCT No.: PCT/EP2018/076323

§ 371 Date: Mar. 16, 2020

(30) Foreign Application Priority Data
Sep. 27, 2017 (DE) 10 2017 122 407.6

(51) Int. Cl. A21D 13/064; A21D 10/00; A21D 8/04; A21D 2/26; A21D 2/18; A23L 33/185; A23L 7/104; A23L 5/20

(52) U.S. Cl. CPC A21D 13/064; A21D 10/005; A21D 8/047; A21D 8/045; A23L 5/20; A21D 2/183; A23L 33/185; A23L 7/104; A21D 2/265

(57) ABSTRACT

The present invention relates to the field of food production, in particular the provision of flour mixtures for the production of bakery products, pasta and bread, which are characterized by a reduced ATI content and can nevertheless be processed into doughs which meet the technical and rheological requirements of a wheat dough.

### FIELD OF THE INVENTION

The present invention concerns the field of food production, in particular the production and supply of bakery products and breads which are digestible despite known food intolerances.

### BACKGROUND

It is known that a significant percentage of the Caucasian population suffers from food intolerances caused by the consumption of cereal products.

One manifestation of this is celiac disease, also known as non-tropical or indigenous sprue or gluten-sensitive enteropathy. Celiac disease is one of the food intolerances or diseases in which the body of an affected patient reacts immunologically to gluten, e.g. the gliadin fraction of wheat and/or the prolamin of rye (secalin) and/or the hordein of barley. This pathogenic reaction to gluten intake manifests itself in inflammation of the small intestine and destruction of the intestinal wall epithelium, thus leading to a sometimes life-threatening resorption disorder.

In recent times it has also been shown that there seems to be another form of food intolerance caused by cereals, in which the patient reacts to a class of proteins called amylase trypsin inhibitors, which is abbreviated as ATI in the following text, with unspecific intestinal complaints.

This clinical clinical picture is now also referred to as wheat sensitivity or non-celiac gluten sensitivity (NCGS) or non-celiac wheat sensitivity (NCWS) or ATI sensitivity. It is estimated that about 10% of the Caucasian population is affected.

It is believed that the presence of ATI in cereal plants makes them more resistant to pest attack, and therefore the gene product has been favoured over the years of breeding in modern cereals. Furthermore, ATI appears to play a role in germ maturation, to have an extremely stable 3D structure, to be resistant to protease and to be only partially destroyed even at high temperatures (e.g. bread baking). Furthermore, ATI has the property of blocking the digestive enzymes for starch and protein and thus itself is only partially digested. Without being bound to this hypothesis, it is currently assumed that this undigested ATI protein leads to immunological or inflammatory reactions in the intestine or reinforces already existing immunological or inflammatory reactions.

An average healthy adult consumes about 150-250 g of wheat flour per day, which is equivalent to 0.5-1 g of ATIs. At this intake level and the mechanism of action proposed and described by Schuppan et al. (2015) via the stimulation of the innate immune system, namely TLR4 stimulation (Schuppan et al., 2015, Best Practice & Research Clinical Gastroenterology 29, pp 469-476), most people cannot expect the occurrence of symptoms. Since no markers are yet available for a clear diagnosis via NCGS, the only option left to the practitioner is an exclusion diagnosis (Fasano et al., 2015, Gastroenterology; 148, 1195-1204).

Furthermore, the only remedy currently available to cure, improve or influence NCGS or, more generally, an intolerance caused by ATI is to refrain from wheat products as far as possible. However, by giving up wheat, patients are very limited and no longer able to eat the most common foods made from flour, such as pasta, bread and baked goods. They are often forced to switch to gluten-free products, although gluten is not responsible for their complaints.

In particular, it has also been shown that ATI-dependent NCGS is dose-dependent, with many patients stating that they tolerate spelt, which contains lower amounts of ATI, better. According to another working hypothesis and preliminary animal data, the intake of ATI also increasingly favours other autoimmune diseases or diseases with chronic inflammatory processes (Schuppan et al., 2015, Best Practice & Research Clinical Gastroenterology 29, pp 469-476).

In order to better serve the needs of affected and NCGS patients and provide them with a wider range of possible foods, there is a need to find a way to provide ATI-free or ATI-reduced wheat products.

WO2015/168416 describes not only quantitative detection methods for ATI from flours and baked goods, including biological test systems (bioassays) that record relevant biological activity, but also an extraction method in which food is treated with an extraction buffer and through this buffer the ATI is to be dissolved or reduced from the food. However, this extraction method requires complete processing and thus complete protein decomposition, so that the treated raw materials are rarely suitable for further industrial or food processing.

Furthermore, it should be mentioned that WO2011/137322 first describes a method in which ATI can be determined and measured by means of a specific antibody from an aqueous solution of a substance. WO2011/137322 thus provides the prerequisite for testing food or processed food for the presence of ATI.

EP 11 775 619.7 further describes an enzymatic degradation process for the removal of ATIs by the use of disulfide reducing microorganisms. In the treatment of wheat flours, however, such a process also leads to compositions which have lost all the properties of a flour and thus any suitability for the production of bread or bakery products.

Therefore, there is a continuing need to develop improved purification processes that allow the gentle treatment of starting materials and the need to provide alternative compositions that allow the production of high quality ATI-free and/or ATI-reduced foods, especially bread and bakery products.

### SUMMARY OF THE INVENTION

While it was previously assumed that an ATI-dependent NCGS is dose-dependent, the inventors were able to confirm the hypothesis that NCGS could be dependent on the type of ATI with the flour mixture on which the invention is based, and products in which only individual ATIs are reduced already show better tolerance.

Currently, 17 different genotypic ATIs have been described, but only the following are identified and/or described in the application; ATI 0.19, ATI 0.28, ATI 0.53 and ATI CM3, ATI CM2, ATI CM16 and ATI CM17. The different types of ATI are identified and quantified on the basis of mass spectrometric data and the detectable cleavage peptides in the liquid chromatography-mass spectrometry/mass spectrometry method (LC-MS/MS method).

In order to provide the flour mixture according to the invention and the pasta or bakery products derived from it, certain ATI-reduced starting products were selected and tested for their ATI composition or ATI content. In particular, protein and starch sources as well as pretreated flours were selected in which the total ATI content or the content of individual ATIs had been reduced by e.g. hydrolytic treatment or enzymatic treatment.

Numerous enzymatic and hydrolytic processes are known in the state of the art to treat flours and especially grain proteins such as gluten (compilation in: Day et al., 2006 Trends in Food Science 17, 82-90). It has been shown that, in particular, treating the protein sources with acids or alkalis (according to Batey et al, 1981 (J Food Technology, 16(5), 561-566); Wu et al, 1976 (J Agricultural and Food Chemistry, 24(3), 504-510)) and thereby reducing the numerous glutamine residues alters the total protein composition of the flour and allows increased leaching of low molecular weight polypeptides.

In this process, the flour or protein and starch sources to be treated are first soaked in slightly salty solutions for 2-4 hours, then treated enzymatically, e.g. with protease, or microbially, e.g. with lactobacilli capable of breaking up disulfide bridges. The pre-treated solution is then centrifuged to separate the proteins. Light and globular proteins, such as all or individual ATIs, can be separated. The remaining batch is then dried and further processed as flour with modified protein content or protein composition.

The inventors were able to show that flours and protein sources pretreated in this way also show a clear shift in ATIs and, in particular, that the reduction of some selected ATIs has a beneficial effect on individuals who show general intolerance reactions and/or disease symptoms when consuming wheat products. The inventors found that especially flour mixtures with a reduced content of ATI 0.19 and/or ATI 0.28 and pasta and baked goods produced from them are preferred by patients with NCGS and can contribute to the relief of ATI-induced symptoms.

### DETAILED DESCRIPTION

The present invention therefore provides a flour mixture characterized by a significantly reduced content of ATI 0.19 and/or ATI 0.28 compared to conventional wheat flours (type 550). The content of ATI type 0.19 and/or ATI type 0.28 in the inventive flour mixture is thereby reduced by at least 40% compared to wheat flour of type 550 or a conventional flour.

Furthermore, it is also beneficial to reduce or control the levels of ATIs CM3 and CM16, both very active immune stimulators.

The reference flour “type 550 wheat flour” is defined according to the German DIN standard 10355.

Analytical measurements of the general and the specific ATI content, in particular the content of ATI 0.19 or ATI 0.28, are carried out within the scope of the present invention by means of LC-MS/MS from enzymatically hydrolysed extracts of the flour or flour mixture to be compared, as well as a comparison of the experimentally generated MS data with published values from databases on the total ATI content in spelt, rye, durum wheat, barley, common wheat, einkorn, emmer and oats.

The inventors have found out that flour mixtures consisting of an isolated ATI-reduced protein and starch source—which optionally contain hydrocolloids—are particularly suitable for the production of bread and bread-like bakery products. The flour mixtures, which are reduced by at least 40% compared to conventional flour and also CM3 and CM16, especially with regard to the content of ATI 0.19 and/or ATI 0.28, are suitable for the production of bread and bread-like bakery products.

Such flour mixtures show a reduced bioactivity and, as confirmed by measurements in the bioassay, an inflammatory bioactivity reduced in some cases by a factor of 6.

According to the present invention, flour mixture is defined as any composition based on ground plant parts, in particular ground plant seeds. Typically, within the scope of the invention, cereal grains, in particular spelt, rye, oats, wheat, barley, emmer, oats and einkorn are ground into flour.

The degree of milling of the flour mixture described can vary from type 405, a typical household flour for cakes, to type 550 for bread, and type 1700, a wheat flour that is almost equivalent to wholegrain flour. The same applies to rye and spelt. The term “degree of milling” refers to the “type” of flour, and clearly explains to the expert the properties defined in German DIN standard 10355, namely, for example, how much of the outer edge layers of the grain, and thus of the mineral content, is contained in the flour. The type number indicates how many milligrams of mineral matter (so-called ash number) are contained in 100 grams of flour. The higher the type number, the higher the mineral content and darker the flour.

Besides the degree of milling, the degree of milling of the plant parts in the flour mixture described herein is also of interest and is expressed in different grain sizes. Typically, flour with an average grain size of up to 150 μm is used in the flour mixture described in the application. For the production of bakery products and breads, as described herein, the flour mixture has a degree of grinding with an average grain or particle size of <1000 μm, further of <750 μm, further particularly suitable are flour mixtures with a degree of grinding of <500 μm, further of <400 μm, further of <300 μm, and finally for special mixtures especially of <150 μm.

In order to carry out a standardized analysis for determining the ATI content of the inventive flour mixture with a reproducible comparative value, a standard type 550 milled wheat flour is used.

The flour used for the described flour mixture can also be composed of isolated protein and starch sources. According to one embodiment, the flour mixture described contains at least 5 wt. % and up to 25 wt. % protein, primarily gluten proteins. Further, according to further embodiments, the flour mixture according to the invention contains 5-20 wt. % protein or 5-15 wt. % protein, preferably 8-18 wt. % protein, alternative 7-25 wt. % protein, 10-25 wt. % protein or 15-25 wt. % protein, further preferably the flour mixture according to the invention contains 6-19 wt. % protein or 10-14 wt. % protein.

It should be noted in particular that these protein sources may, but need not, contain gluten.

Furthermore, it should be noted that in the context of the invention gluten or gluten protein is a collective term and stands for a mixture of substances consisting of different proteins which occur in the seeds of some types of cereals, whereby this collective term also designates the protein source, according to the present application.

Correspondingly, the protein source used is selected from the group consisting of spelt, wheat, rye, barley, oat, emmer or einkorn flour, as well as isolated cereal gluten variants, isolated wheat gluten, isolated gluten variants of spelt, wheat, rye, barley, oat, emmer or einkorn, but also isolated gluten components of spelt, wheat, rye, barley, oat, emmer or einkorn as well as mixtures of the above-mentioned.

Alternatively, according to other embodiment forms, the protein source is gluten-free and the flour mixture is produced by using and grinding pseudo-cereals or other gluten-free, protein-rich sources selected from the group consisting of amaranth, quinoa, chia, buckwheat, rice, corn, millet, teff, flaxseed, legumes, chestnuts and mixtures thereof.

According to other embodiments, the starch sources added to the flour mixture may also, but need not, contain gluten.

Accordingly, according to such embodiments, the starch source used is selected from the group comprising wheat starch, soft wheat starch and durum wheat starch, as well as a mixture of wheat starch and at least one further starch source, namely corn starch, potato starch, tapioca starch, hydrolyzed starch, rye starch, oat starch, barley starch, arrowroot starch, banana starch, rice starch or mixtures thereof.

According to one embodiment, the flour mixture described contains at least 50% by weight and/or up to 96% by weight starch. Further, according to further embodiments, the flour mixture according to the invention contains 55-90% by weight starch, 65-85% by weight starch, 75-85% by weight starch, 70-92% by weight starch, 60-85% by weight starch or 80-96% by weight starch.

The inventors were able to show that doughs produced with ATI-reduced protein and starch sources exhibit good to excellent elasticity and viscosity depending on their composition. For example, a protein content of 5-15 wt. % together with a starch content of 70-92 wt. % or more than 80 wt. % leads to doughs with dough properties comparable to those of standard flour type 550 (example 1).

It has also been shown that the desired effects of better tolerance already occur with an ATI reduction of at least 40% compared to unmodified normal products, namely a standard wheat flour type 550. Therefore, the flour mixture according to the invention is characterized by the fact that the starting products used and the end product, i.e. the mixture itself, have an ATI reduction of at least 40% compared to a standard wheat flour type 550.

Further according to alternative embodiments, the starting products used and the end product have an ATI reduction of at least 50% compared to a standard wheat flour type 550, further of at least 60% compared to a standard wheat flour type 550, further of at least 70% compared to a standard wheat flour type 550, further of at least 80% compared to a standard wheat flour type 550, further of at least 90% compared to a standard wheat flour type 550 or also of 100% compared to a standard wheat flour type 550.

An essential feature of the present invention is the use of ATI-reduced starting substances. ATI is used in the present application as an abbreviation and collective name for a subgroup of wheat proteins, namely the family of alpha-amylase/trypsin inhibitors. The currently known family of ATIs consists of 17 different protein variants with a molecular weight of approximately 15 kD. ATIs are compact, water-soluble proteins consisting of several highly conserved alpha-helix structures connected via disulphide bridges and are further characterized by a high protease resistance. Typically, ATI proteins are found in gluten-containing food or directly in isolated gluten in a proportion of approx. 2-4%.

The inventors were able to show that the use of starting substances with a reduced proportion of some selected ATIs is particularly advantageous. Thus, according to the invention, starting substances with a reduced ATI content, in particular a reduced ATI content selected from the ATIs consisting of the group ATI 0.19, ATI 0.28, CM3, CM16 and CM17 are to be preferred.

The flours or other starting substances used in the context of the present invention are therefore tested for the content of the selected ATIs. Thus, according to some embodiments, flours and starting materials are used which were selected on the basis of a naturally occurring low or industrially reduced ATI 0.19 content and/or ATI 0.28 content. Furthermore, the ATI content can also be reduced by various known methods, so that starting materials with a reduced ATI 0.19 content and/or ATI 0.28 content are then available.

Various methods are known for measuring the ATI content. Prandi et al., (Food Chemistry 2013, 141-146) describes e.g. the LC/MS analysis to determine the ATI CM3 content. The abbreviation LC/MS (often also called HPLC-MS) refers to the combination of liquid chromatography with mass spectrometry coupling. In order to separate the molecules of a solution, chromatography or liquid chromatography is performed and then the separated substances (molecules) are identified and/or quantified by mass spectrometry.

However, one of the difficulties of the LC/MS procedure is the interface between the two individual procedures. Both the excess sample volume and the solvent must be disposed of, which often causes contamination and defects in the interface. To overcome these problems, electrospray ionization (ESI) or chemical ionization at atmospheric pressure (APCI) are often used in the ionization process today. A further possibility, which can be used in the context of the present invention, is a nano-LC/MS whereby in this case the sample volume is reduced and the separation is carried out with a significantly lower flow rate.

However, the method that has proved most effective in the context of the invention is the double coupling of mass spectrometry with liquid chromatography, also known as LC-MS/MS, which allows a better and more meaningful examination of the substances present. This method is very common in research today, especially in the disciplines of proteomics and pepdidomics, because with the LC-MS/MS method it is possible to identify and quantify not only pure substances but also substances in substance mixtures.

However, it is necessary to prepare the samples to be analyzed in advance, which is time-consuming. The methods described below for preparing a sample which is then subjected to an LC-MS/MS procedure are all part of the known state of the art and can all be used, alone or in combination, for the analysis under the present application.

One of the best known methods is one- or two-dimensional (1D or 2D) polyacrylamide gel electrophoresis (PAGE), whereby the proteins are extracted from the gel as a proteolytic fragment and then analyzed by a MS method.

The (PAGE) method is very robust and stable, but due to its low resolution it is sometimes unsuitable for complicated mixtures. For this reason, nowadays a gel-free separation is often performed, using a pH solution instead of the gel to separate the peptides. The proteins and peptides are immobilized on a pH gradient (IPG) gel, then separated by migration and oriented by diffusion onto a well next to the IPG strip.

As an alternative to the above methods, proteins are often separated based on their biochemical and biophysical properties using (immuno-) affinity chromatography, removing the protein that is most present. Typically, this is done by dye-based separation or separation using antibodies.

Furthermore, there are numerous other methods which are suitable for analyzing the starting substances and flours within the scope of the present invention, but these are only briefly mentioned here:

Ultrafiltration can be installed upstream and separates the total proteins into several fractions by centrifugation.

Organic solvent precipitation, where the proteins with higher molecular mass are precipitated by adding an organic solvent and leave the low-molecular proteins in the solution, including all peptides. It is also possible to use ammonium sulfate instead of the organic solvent, but this can lead to contamination of the interface in a later LC-MS/MS step.

In addition to the above-mentioned HPLC liquid chromatography, alternative methods can also be used, including the following:

Gel Permeation Chromatography (GPC) as a type of liquid chromatography in which individual molecules of dissolved substances are separated on the basis of their size (more precisely: their hydrodynamic volume).

Reverse phase chromatography, where the individual molecules are separated based on their different hydrophobic properties.

Ion exchange chromatography, which separates proteins in a specific salt environment and at a specific pH based on their charge

For complex biological samples, several multidimensional separations are often indicated, and all the methods described above can be combined. All these methods and combinations of these methods are part of the stale of the art and can be used to select suitable starting materials and flours with reduced ATI content within the scope of the invention.

The starting substances according to the present invention have a significantly reduced content of ATI. In particular, the starting substances and flour mixtures according to the present invention have a reduced content of ATI 0.19 and/or ATI 0.28, while the content for other ATIs is or can be almost unchanged.

Reference is made to example 9, in which the ATI content of different ATIs was determined by means of LC/MS+MS for a flour mixture according to the invention in comparison to standard flour (FIG. 1).

Further investigations showed that the bioactivity of the ATI contained in the flour mixture according to the invention differs significantly from the ATI-induced bioactivity of a standard flour.

FIG. 9 shows, for example, the result of an IL8 specific ELISA assay, for which suitable test cells, namely ATI reactive cells—according to WO2017075456 e.g. TLR4 expressing cells, preferably TLR4 expressing monocytes—are contacted with ATI extracts (buffer extraction) and subsequently the cytokine release, namely an IL8 release in the supernatant is measured by ELISA. Junker et al. developed this bioactivity test and described for the first time in Junker et al. (Wheat amylase trypsin inhibitors drive intestinal inflammation via activation of toll-like-receptor, Journal Experimental Medicine 201, 209: 2395-2408).

The inventors were able to show that the flour mixture according to the invention triggers a significantly lower cytokine release in the ATI bioactivity test in comparison with a standard flour. Thus, patients who are ATI-sensitive and who may show various NCGS symptoms can expect a significantly better tolerance and digestibility of products made from the flour mixture according to the invention, since no ATI-induced immunological or allergic reactions are to be expected.

According to another embodiment, the ATI bioactivity measurement of a flour mixture according to the invention shows a bioactivity corresponding to an IL8 release of between about 10 versus about 115 ng IL-8 per gram of the mixture and is detectable in the IL-8 specific ELISA assay.

It also shows that not all ATIs need to be reduced to achieve the positive effect in terms of baking properties and better tolerance. It is not harmful, but also not necessary that others than ATI 0.19 or ATI 0.28 are reduced in order to provide the general objective of the present invention, namely a flour mixture suitable for the production of bread and bakery products, or products with better tolerance for patients in general and especially for patients with non-celiac disease gluten sensitivity.

Further investigations showed that in the flour mixture according to the invention and through the enzymatic or hydrolytic pretreatment of the flours, the proportion of fructooligosaccharides (FODMAP) naturally present in the flour, namely fermentable oligo-, di-, monosaccharides or polyols, is also significantly reduced. In standard measurements it could be shown that the proportion of FODMAPs in the flour mixture according to the invention is reduced by a factor of 10 in comparison with commercial wheat flour (example 10).

The flour mixture according to the invention is thus additionally extremely well tolerated by patients who have an increased sensitivity to the presence of oligosaccharides in general (FOS, XOS, or GOS) and also of FODMAPs, in particular bacterially fermentable oligo-, di-, monosaccharides or polyols.

The flour mixture according to the invention is still particularly interesting because, despite the reduced ATI content and the resulting change in the grain protein content, it is particularly suitable for the production of baked goods and bread.

In various test series, the inventors were able to show that and how different compositions of the flour mixture, or different protein or starch fractions of the flour mixtures, affect the dough properties and in particular the elasticity, dough viscosity, extensibility and kneading behaviour (examples 1-4).

In numerous other test series, the use of hydrocolloids and other baking additives and their effects on the dough properties of the dough produced with the flour mixture according to the invention was investigated (Example 4-6).

Accordingly, it could be shown that, according to other embodiments, the flour mixture according to the invention can—optionally—contain one or more hydrocolloids. Typically for this purpose, the one or more hydrocolloids are selected from the group containing psyllium, guar gum, chia seed flour, linseed flour, xanthan gum, tragacanth, konjac, gum arabic, karaya, sunflower seed flour and HPMC (hydroxy-propyl-methylcellulose).

The flour mixtures according to the invention contain up to 3% by weight of one or more hydrocolloids according to a further embodiment. According to further embodiments, the flour mixture according to the invention contains between 0 and 0.5% by weight or between 0 and up to 1% by weight of hydrocolloids, further up to 2% by weight of hydrocolloids, further up to 3% by weight of hydrocolloids.

When used moderately, the hydrocolloids increase and improve the dough properties and in particular the viscous dough properties, which were determined and compared in the Farinograph during the analysis of the kneading behavior (example 5).

Furthermore, the hydrocolloids influence the gas retention properties and thus also the volume yield of the baked goods. In any case, it can be stated here that the addition of hydrocolloids is not necessary, but also not harmful and in some cases desirable in order to obtain an end product comparable to wheat bread.

Furthermore, it could be shown that, according to other embodiments, the flour mixture according to the invention can contain one or more baking additives—optionally. Typically for this purpose, the one or more baking additives selected from the group comprising ascorbic acid, malt flours, amylases, xylanases, proteases, lipases, lipoxygenases, glucose oxidase, cellulases, hemicellulases, lecithins, phosphates, mono- and diglycerides of fatty acids, emulsifiers, cysteine, and mixtures thereof, and further comprising leavening agents, yeast, sourdough, sourdough concentrate and dried sourdough.

The baking additives added to the flour mixture only have the task of influencing the baked goods to be produced with regard to their browning, volume development or taste coordination or taste development and to make them similar or comparable to wheat bread in the highest form. Other baking additives known to the specialist or common baking additives can be added to the flour mixture without changing the inventive core and the desired compatibility.

Taste tests were therefore also used to determine whether the baked goods produced with the inventive flour mixture were comparable to conventional wheat breads. For this purpose, rolls and breads were produced from the trial mixture 17 (inventive mixture) and trial mixture 1 (commercial wheat flour) and tasted and compared by testers. The optical impression (colouring and appearance), odour and aroma, taste as well as texture and feel were evaluated.

The result shows that although the testers gave different evaluations and differences could be perceived, particularly with regard to taste, it is also apparent that in the overall impression the products made from standard flour or the ATI-reduced flour mixture are highly similar and comparable (FIG. 8).

In accordance with other embodiments, the ATI-reduced flour mixture is mixed with sourdough, sourdough concentrate, baking additives and/or leavening agents. The sourdoughs or sourdough concentrates used contain one or more strains or pure breeding strains from the group of microorganisms containing L. acidifarinae, L. acidophilus, L. alimentarius, L. amylovorus, L. brevis, L. buchneri, L. cellobiosus, L. coleohominis, L. collinoides, L. crispatus, L. crustorum, L. curvatus, L. delbrueckki, L. farciminis, L. fermentum, L. fructivorans, L. frumenti, L. gallinarum, L. gasseri, L. hammesii, L. helveticus, L. hilgardii, L. homohiocchi, L. johnsonii, L. kefiri, L. kimchi, L. kunkeei, L. linden, L. mall, L. mindensis, L. mucosae, L. nagelii, L. nantensis, L. namurensis, L. nodensis, L. oris, L. panis, L. paralimentarius, L. parabuchneri, L. paracasei, L. pentosus, L. perolens, L. plantarum, L. pontis, L. reuteri, L. rossiae, L. sakei, L. sanfranciscensis, L. secaliphilus, L. siliginis, L. spicheri, L. vaginalis, L. zymae, and others Lactococcus lactis, Leuconostoc citreum, L. gelidum, Lc. mesenteroides, Pediococcus acidilactici, Pediococcus damnosus, P. parvulus, P. pentosaceus, Weissella ciboria, Weissella confusa, Weissella kandleri, Weissella paramesenteroides, Weissella viridescens, Candida milleri (Kazachstania mitten), Candida humilis, Kazachstania exigua, Saccharomyces cerevisiae, Debaryomyces hansenii, Dekkera bruxellensis, Kazachstania unispora, Kluyveromyces lactis, S. bayanus, Saccharomyces pastorianus, Torulaspora delbrueckii, T. pretoriensis, Wickerhamomyces anomalus, Pichia anomala, Hansenula anomala, Pichia kudriavzevii, Issatschenkia orientalis, Candida krusei and mixtures thereof.

Furthermore, the present invention provides a process for the reduction of ATIs in flour for which a flour mixture with live sourdough and/or sourdough starters is prepared and fermented.

For this purpose, the present invention provides a living sourdough and sourdough starter capable of modifying the ATI content in the prepared flour and/or dough. The selected mixture is characterized in particular by the fact that the contained cultures and pure breeding strains are capable of metabolising and/or reducing ATI 0.19 and/or ATI 0.28.

The live sourdoughs and sourdough starters provided within the scope of the invention, which are capable of influencing the ATI content in the flour according to the invention, therefore contain at least one of the sourdough yeasts Candida milleri, Candida humilis and/or Kazachstania milleri as the lead organism. Furthermore, the sourdoughs or sourdough starters according to the invention can contain at least one or more further sourdough yeast strains selected from the group Kazachstania exigua, Debaryomyces hansenii, Dekkera bruxellensis, Kazachstania unispora, Kluyveromyces lactis, Torulaspora delbrueckii, T. pretoriensis, Wickerhamomyces anomalus, Pichia anomala, Hansenula anomala, Pichia kudriavzevii, Issatschenkia orientalis, Candida krusei and mixtures thereof. For the strains of the genus Saccharomyces often found in sourdough, no amount for ATI reduction could be detected in the flour mixture. Their presence is therefore not necessary, but also not disturbing.

Furthermore, preferably the sourdoughs of the invention contain at least one microorganism from the group L. pontis, L. sanfranciscensis and L. reuteri. The presence of other known strains of sourdough in the sourdough according to the invention has no or only little additional effect on the ATI content and thus does not—according to the inventors' current knowledge—interfere with its reduction by the selected organisms. Accordingly, all sourdoughs which reduce ATI by means of the selected strains and especially the sourdough yeast Kazachstania milleri fall under the inventive approach.

In this combination, the selected strains are particularly suitable for producing ATI-reduced flour mixes for tasty breads and bakery products, as they change the protein composition of a flour mix to a particular degree. By using the selected strains, a dough is produced which, with respect to its ATI composition, benefits from the metabolic interactions of the selected strains and, in addition, shows gas retention properties or rheological properties of a normal wheat sour dough.

According to the present application, the ATI-reduced flour mixture, with and without the optionally added further ingredients, is also particularly suitable for the production of pasta, pasta, pastry products and, of course, classic bread and bakery products. Depending on taste or recipe, egg, egg white, egg yolk, ready-to-eat egg, milk, yeast, sugar, salt, bread spices, gluten-free cereals and/or pseudo-cereals can be added as grains and/or ground.

Typically, all secondary products produced from the invention's ATI-reduced flour mixture are ATI-reduced in total ATI content by at least 40%, at least 50%, at least 60%, further by 70%, further by 80% and even up to 90% compared to products produced from type 550 flour (FIG. 9). A variation (extension) in the duration of the fermentation time with the sourdough according to the invention changes the ATI content of the flour mixture and this can thus be adjusted as required.

Thus, for the flour mixture according to the invention in the bioactivity test according to Junker et al. (2012), an IL-8 release of less than 10 ng/g flour mixture could be detected in the IL-8 Elisa test (ThermoFischer scientific), whereas in comparison, the commercially available flour mixture resulted in an IL-8 release of approx. 116 ng/g flour. This corresponds to a more than 90% reduction in ATI-specific bioactivity compared to the results with commercial flour. According to current knowledge—but without being bound by the hypothesis—the compatibility of the flour mixture according to the invention is guaranteed with an ATI-specific bioactivity, which is expressed in an IL-8 release of up to 60 ng/g IL-8 per g of flour mixture.

The bakery products and/or pasta produced within the scope of this invention are therefore particularly compatible, provided they have a reduced total ATI content of at least 40%, but still 50%, 60%, 70%, 80% and in particular 90%.

### SHORT DESCRIPTION OF THE FIGURES

FIG. 1 shows the results of the differentiated ATI determination of the LC/MS+MS analysis. Double determination; white bar=commercial wheat flour of type 550; black bar=flour mixture according to invention, triple determination; peak areas are compared; however, all samples were treated in the same way and recorded in the same volume. For the ATIs 0.19, 0.28 and CM3 two peptides were used; of CM2 and CM16 only one peptide each. While the ATIs 0.29 and 0.28 are significantly reduced in Flour B, no difference can be seen for ATIs CM2, CM3 and CM16.

FIG. 2 shows the results of the farinograph measurement and thus the kneading behaviour of the different test mixtures 1-7. The farinograms of various test mixtures are shown; Experiment 1 (- wheat flour 550), Experiment 2 (--- without gluten), Experiment 3 (-- -- without psyllium), Experiment 4 (- - - 13% gluten 2.9% psyllium), Experiment 5 (13% gluten 0.8% psyllium), Experiment 6(-- - -- 6.8% gluten 3.2% psyllium), Experiment 7 (--- --- 13% gluten 0.8% psyllium 2% Germe).

FIG. 3 shows the influence of different wheat gluten on the kneading behaviour.

FIGS. 4A and B show the influence of different amounts of wheat gluten on the baking behavior. The visually recognizable differences show bread baked from doughs with a gluten content of (from left to right) approx. 4%, approx. 12% and approx. 19% wheat gluten.

FIG. 5 shows the influence of different amounts of starch on the kneading behaviour (farinograph measurement).

FIG. 6 shows the influence of different amounts of starch on baking behaviour (photo): crumb pictures of tin loaves with different starch contents based on ATI-reduced basic mix; from left to right: approx. 95%, approx. 83%, approx. 70% and approx. 50% starch.

FIGS. 7A and B show the results of baking trials with various baking additives (from left to right (from left to right): ascorbic acid, diastase malt and ascorbic acid, a amylase and ascorbic acid.

FIG. 8 shows the result of a tasting by 14 tasters. Here, rolls and breads made from commercial wheat flour were compared with rolls and breads made from the flour mixture according to the invention.

FIG. 9 shows the results of the ATI bioactivity analysis according to Junker et al (2012) on human monocytes.

### EXAMPLES

### Example 1: Influence of Different Compositions on the Dough Properties

Various mixing ratios of ATI-reduced wheat starch and ATI-reduced isolated wheat gluten were compiled and tested. The test doughs were kneaded in the farinograph until the maximum viscosity was reached. The doughs were round knitted with the roll press. The dough was then left to rest for 15 minutes. The doughs were then gently kneaded for a long time and formed into small strips of dough using the press. After a further rest period of 35 minutes, the measurement was carried out.

TABLE 1
Test formulations and production overview

| | Formulation | | | | | | |
|---|---|---|---|---|---|---|---|
| Ingredients (g) | #1 | #2 | #3 | #4 | #5 | #6 | #7 |
| Wheat flour (type 550) | 300 | 0 | 0 | 0 | 0 | 0 | 0 |
| | (100%) | | | | | | |
| Wheat starch | 0 | 294 | 252 | 249 | 254 | 267 | 245 |
| | | (96%) | (85%) | (83%) | (85%) | (89%) | (82%) |
| Wheat gluten A | 0 | 0 | 39.6 | 39.1 | 39.9 | 20.3 | 38.5 |
| | | | (13%) | (13%) | (13%) | (6.8%) | (13%) |
| Psyllium | 0 | 8.9 | 0 | 8.9 | 2.4 | 9.5 | 2.3 |
| | | (2.9%) | | (2.9%) | (0.8%) | (3.2%) | (0.8%) |
| Rapeseed oil | 0 | 4.2 | 3.6 | 3.6 | 3.6 | 3.8 | 3.5 |
| | | (1.4%) | (1.2%) | (1.2%) | (1.2%) | (1.3%) | (1.2%) |
| Sourdough | 0 | 0 | 0 | 0 | 0 | 0 | 10.5 |
| (Böcker Germe) | | | | | | | (3.5%) |
| Water | 174 | 225 | 179 | 197 | 205 | 225 | 198 |
| Kneading time | 6 | 6.8 | 10 | 8 | 10 | 11.8 | 8.1 |
| (min) | | | | | | | |
| max. viscosity | 547 | 333 | 390 | 561 | 364 | 342 | 326 |
| in the Farino- | | | | | | | |
| graph (FE) | | | | | | | |

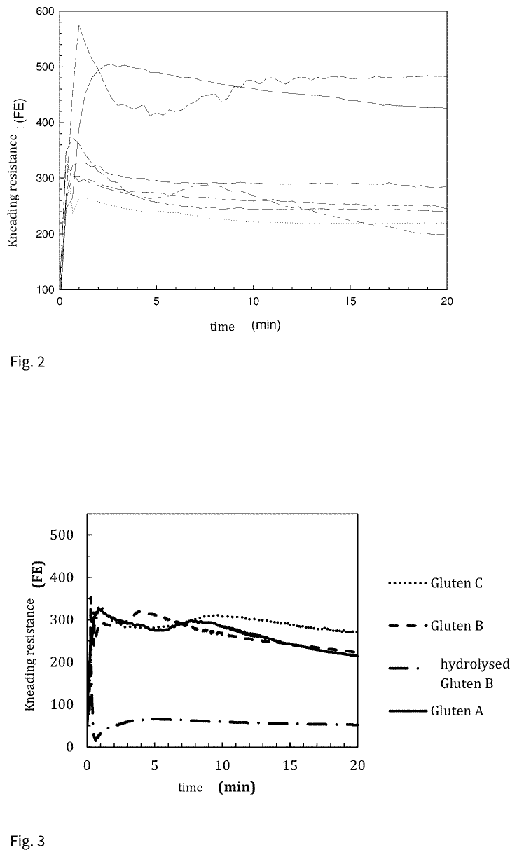

FIG. 2 shows the results of the farinograph measurement and thus the kneading curves or kneading behaviour of the different test mixtures 1-7 in comparison with type 550 wheat flour.

For this purpose, the doughs were examined with the various test mixtures (see Table 1 for an overview of the recipes) in the farinograph at a kneading time of 20 min at 30° C. and a speed of 63 rpm.

Table 2 below also lists the elongation and elongation resistance. The tests show clear differences between all the compounds used. Test mix 1, represents a control and shows the extensibility and max. viscosity of normal wheat flour.

TABLE 2
Measurement parameters microextensogram

| | Elongation | max. elongation |
|---|---|---|
| Trial | (mm) | resistance (mN) |
| 1 | 33.43 | 164 |
| 2 | 7.75 | 126 |
| 3 | 11.74 | 131 |
| 4 | 10.96 | 317 |
| 5 | 9.04 | 114 |
| 6 | 7.59 | 152 |
| 7 | 8.81 | 86 |

### Example 2: Influence of Different Wheat Gluten on the Kneading Behaviour

The influence of different adhesives and isolated adhesive proteins on the rheological properties of the dough was investigated.

The different adhesives were used in the following formulation (#8), the amounts were not varied.

TABLE 3

| Formulation #8 | Quantity (g) |
|---|---|
| Wheat starch | 245 |
| Wheat gluten | 38.5 |
| Psyllium | 2.3 |
| Rapeseed oil | 3.5 |
| Germe | 10.5 |
| Water | 198 |

For this purpose, gluten, i.e. isolated wheat gluten, was tested by various manufacturers. The results of the kneading curves are shown in FIG. 3.

Of particular interest was the result on hydrolysed gluten, where the kneading resistance is significantly reduced, as can be seen from the kneading curve. The other glues show a comparable kneading resistance, but the “2nd” increase is at different times.

### Example 3: Influence of Different Amounts of Wheat Gluten on Baking Behaviour

The influence of different doses of wheat gluten should be investigated to determine the tolerance ranges of wheat gluten quantities. The amount of wheat gluten used in the previous test series was approx. 13% and represents the standard. In comparison, mixtures with approx. 4% up to approx. 20% gluten (based on the total amount of ingredients without water) were tested.

TABLE 4
Test formulations

| | Recipe: #9 | | Formulation #10: | | Formulation #11: | |
|---|---|---|---|---|---|---|
| Raw material | with approx. | | with approx. | | with approx. | |
| in (g) | 4% adhesive | | 12% adhesive | | 19% adhesive | |
| Wheat starch | 1050 | | 1050 | | 1050 | |
| Wheat gluten | 50 | | 165 | | 280 | |
| Psyllium | 10 | | 10 | | 10 | |
| Germe | 24.8 | | 24.8 | | 24.8 | |
| Rapeseed oil | 12 | | 12 | | 12 | |
| Yeast | 40 | | 40 | | 40 | |
| Salt | 25 | | 25 | | 25 | |
| Sugar | 15 | | 15 | | 15 | |
| TOTAL (g) | 1226.8 | | 1341.8 | | 1456.8 | |
| Water (22° C.) | 735 | | 810 | | 900 | |
| Kneading time | 2 + 8 | | 2 + 9 | | 2 + 9 | |
| Dough rest | 15 | minutes | 15 | minutes | 15 | minutes |
| Weighing in (g) | 650 | | 650 | | 650 | |
| Fermentation time | 40 | min | 40 | min | 40 | min |

The doughs with an adhesive content of less than 5% had almost no elastic properties. The doughs with an adhesive quantity of approx. 20% or more, on the other hand, had a rubbery consistency.

It was noticeable that the doughs had a very strong “gluten smell”. The ready-baked breads with a gluten dosage of approx. 20% had a very rubbery chewing behaviour, which is very untypical compared to a conventional wheat bread.

Overall it can be said that the doses of 5 and 20% show extremes and have a negative influence on the quality of the baked goods in different ways. Ideally, an adhesive quantity of 6%-19% should be used.

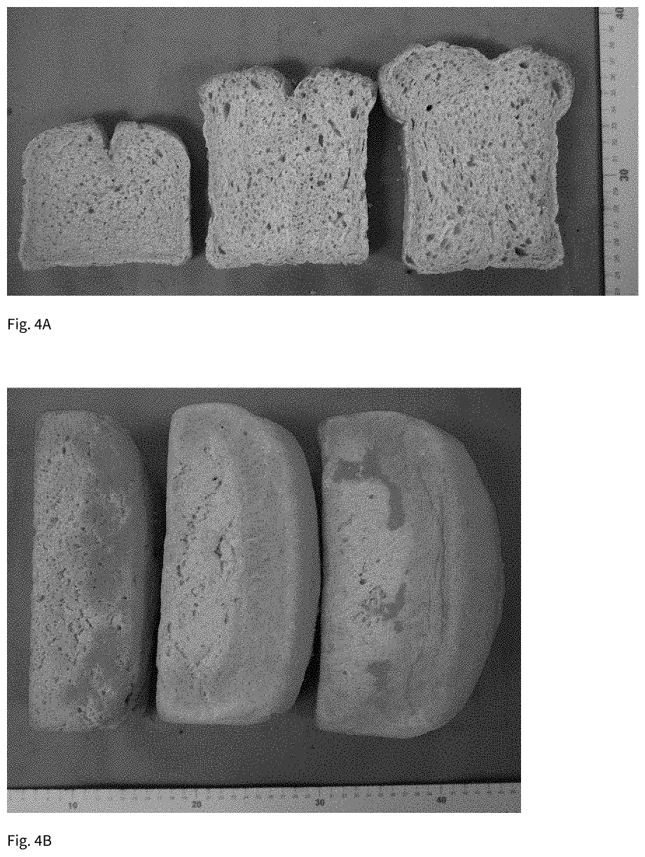

FIGS. 4A and 4B show the visually recognisable differences between breads baked from doughs with a gluten content of (from left to right) 4%, 12% and 19% wheat gluten.

### Example 4: Use of Different Amounts of Starch and their Effect on Dough Properties and Baking Behaviour

In this test series, the influence of different starch contents in the basic formulation of the ATI-reduced mixture was investigated. This makes it possible to estimate the variability of the base mix for subsequent product variants.

In the test series, the dough properties were investigated using a farinograph. Baking trials were carried out to assess the influence of the different starch contents on the baking properties. The following starch contents were examined: 83% (hrs), 95%, 70% and 50%.

The following Table 5 shows the recipe and the measured parameters.

| | Quantity (g) | Quantity (g) | Quantity (g) | Quantity (g) |
|---|---|---|---|---|
| | for approx. | for approx- | for approx- | for approx- |
| | 83% starch | imately | imately | imately |
| Formulation | (standard) | 95% starch | 70% starch | 50% starch |
| Wheat starch | 249.2 | 285 | 210.0 | 150.0 |
| Wheat gluten | 39.2 | 3.3 | 78.3 | 138.3 |
| Psyllium | 3.0 | 3.0 | 3.0 | 3.0 |
| Germe | 5.3 | 5.3 | 5.3 | 5.3 |
| Rapeseed oil | 3.3 | 3.3 | 3.3 | 3.3 |
| Water | 195.8 | 195.8 | 195.8 | 195.8 |
| (TA 165) | | | | |
| Measurement | | | | |
| parameters | | | | |

| | |
|---|---|
| Speed (rpm) | 63 |
| Dough tem- | 30 |
| perature (° C.) | |
| Measuring | 20 |
| duration (min) | |

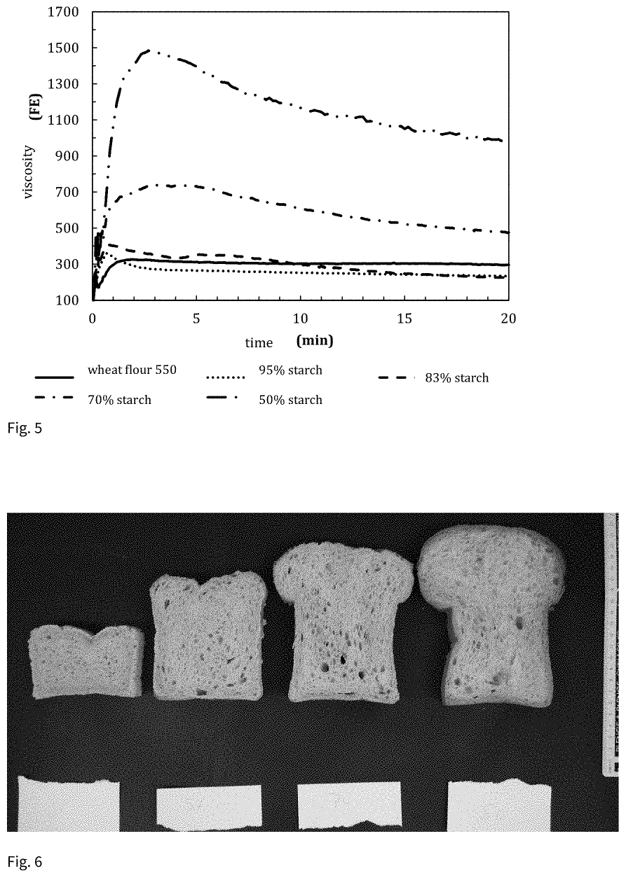

The Farinograph measurement (FIG. 5) shows that the use of different starch contents has a significant influence on the kneading properties of the doughs/masses, thus changing the overall curve characteristics. The similarity of the curves for wheat flour 550 and the test mass with 95% starch content is striking, but this provides little information about baking properties. The extent of the differences in processing and baking properties can be assessed on the basis of the baking results (FIG. 6) and the following description.

### Baking Trial:

The following Table 6 shows the recipe and the production parameters of the baking tests, as well as their results.

| | Quantity (g) | Quantity (g) | Quantity (g) | Quantity (g) |
|---|---|---|---|---|
| | for approx. | for approx- | for approx- | for approx- |
| | 83% starch | imately | imately | imately |
| Formulation | (standard) | 95% starch | 70% starch | 50% starch |
| Wheat starch | 1050 | 1200 | 885 | 632 |
| Wheat gluten | 165 | 14 | 330 | 583 |
| Hydrocolloid X | 12.62 | 12.62 | 12.62 | 12.62 |
| Germe | 22.5 | 22.5 | 22.5 | 22.5 |
| Rapeseed oil | 14 | 14 | 14 | 14 |
| Yeast | 45 | 45 | 45 | 45 |
| Salt | 30 | 30 | 30 | 30 |
| Sugar | 15 | 15 | 15 | 15 |
| Water (22° C.) | 825 | 825 | 825 | 825 |
| Production | | | | |
| parameters | | | | |

| | |
|---|---|
| Kneading (min) | 2 slow + 9 fast |
| Dough tem- | 29 |
| perature (° C.) | |
| Weighing in | 750 (in loaf pan) |
| (g) | |
| Gare (min) | 45 |
| Baking tem- | 240 falling to 210 |
| perature (° C.) | |
| Baking time | 45 |
| (min) | |
| Miscellaneous | Cut the bread after cooking |

Results:

| | Dough temperature | Baking loss | Volume | Specific volume | |
|---|---|---|---|---|---|
| Sample | (° C.) | (%) | (ml) | (ml/g) | Remarks |
| 83% | 29 | 16.1 | 1960 | 3.1 | — |
| Starch | | | | | |
| 95% | 26 | 18.6 | 1235 | 2.0 | Dough: moist, sticky, not |
| starch | | | | | workable |
| | | | | | Bread: no bread quality |
| 70% | 36 | 18.2 | 2820 | 4.6 | Dough: rubbery, strong |
| starch | | | | | heating of the dough, not |
| | | | | | workable |
| | | | | | Bread: very strong oven |
| | | | | | baking, crumbling crumb |
| | | | | | (still acceptable) |
| 50% | 37 | 19.6 | 4750 | 7.9 | Dough: rubbery, strong |
| starch | | | | | heating of the dough, not |
| | | | | | workable |
| | | | | | Bread: very strong oven drift, |
| | | | | | balling and rubbery crumb |

### Example 5: Use of Different Hydrocolloids and their Effect on Dough Properties and Baking Behaviour

In this test series, the influence of different hydrocolloids on the base mix for the production of ATI-reduced baked goods was investigated. The results should ensure that the functionality of the base mix is not bound to a specific hydrocolloid. The dosages of all hydrocolloids were 1% (based on ingredients WITHOUT water). This represents a typical dosage of hydrocolloids in baked goods.

In order to assess the influence of the different hydrocolloids on the baking properties, baking tests were carried out. The following hydrocolloids were investigated:
No hydrocolloid, missing hydrocolloid was replaced by wheat starch (Abbreviation: NONE)
Psyllium, is used as standard with 0.8% in the basic recipe (abbreviation: Psy (standard))
Guar gum (3500 cps) (Abbreviation: Guar)
HPMC (4000 cps) (Abbreviation: HPMC)
Xanthan gum (1550 cps) (Abbreviation: Xan)
Traganth (400 cps) (Abbreviation: Trag)
Konjac (36000 cps) (Abbreviation: Konj)
Gum Arabic (-cps) (Abbreviation: Ara)
Karaya (-cps) (Abbreviation: Kara)

### Baking Trial:

Table 7 shows the basic recipe and the production parameters of the baking trials:

| Formulation | ingredients | Quantity (g) |
|---|---|---|
| | Wheat starch | 1245.9 |
| | Wheat gluten A | 195.8 |
| | Hydrocolloid X | 15.0 |
| | Germe | 26.7 |
| | Rapeseed oil | 16.6 |
| | Yeast | 45 |
| | Salt | 30 |
| | Sugar | 15 |
| | Water (22° C.) | 979 |
| Manufacturing | Kneading (min) | 2 slow + 9 fast |
| parameters | Dough temperature (° C.) | 29 |
| | Weighing in (g) | 750 (in loaf pan) |
| | Gare (min) | 45 |
| | Baking temperature | 240 falling to 210 |
| | (° C.) | |
| | Baking time (min) | 45 |
| | Miscellaneous | Cut the bread after cooking |

The following Table 8 shows the results of the baking tests using the various hydrocolloids or without hydrocolloid.

TABLE 8

| | Back | Vol- | Specific | |
|---|---|---|---|---|
| | loss | ume | volume | |
| | (%) | (ml) | (ml/g) | Remarks |
| NO | 15.9 | 2213 | 3.5 | dough: soft and sticky, difficult to cut |
| | | | | after cooking, no stall |
| | | | | Bread: sides no cracks |
| Psy | 15.7 | 1875 | 3.0 | Dough: good working properties, long |
| (hrs.) | | | | kneading time for dough formation |
| | | | | Bread: low oven drift, slight cracks on |
| | | | | the side |
| Guar | 16.7 | 2300 | 3.7 | Dough: comparable with Psy (hrs) |
| | | | | bread: no cracks on the side |
| HPMC | 18.9 | 2360 | 3.9 | Dough: soft, moist and sticky, little |
| | | | | standing, difficult to cut after cooking |
| | | | | Bread: very good baking, slight cracks |
| | | | | on the side (less than at Psy Std.) |
| Xan | 15.2 | 1805 | 2.8 | Dough: doughs appear “dry |
| | | | | Bread: strong cracks on the side |
| Trag | 16.1 | 2230 | 3.5 | Dough: soft and moist, no stall |
| | | | | Bread slight cracks on the side |
| Account | 16.1 | 2180 | 3.5 | Dough: firm and not sticky (compare |
| | | | | with Psy Std.) |
| | | | | Bread: very strong cracks on the side |
| Macaw | 17.2 | 2120 | 3.4 | Dough: soft and moist, no stall, difficult |
| | | | | to cut after cooking |
| | | | | Bread: slight cracks on the side |
| Kara | 16.5 | 2115 | 3.4 | Dough: compare with Psy Std. |
| | | | | Bread: strong cracks on the side |

### Example 6: Use of Different Baking Additives and their Effect on Dough Properties and Baking Behaviour

The influence of different baking additives should be investigated. Formulation 10 from the previous trials was used as a basis.

TABLE 9

| | Formulation #11: | | Formulation #12: | | Formula #13: | |
|---|---|---|---|---|---|---|
| Raw material | with ascorbic | | Diastase Malt and | | α Amylase and | |
| in (g) | acid (g) | | ascorbic acid (g) | | ascorbic acid (g) | |
| Wheat starch | 1050 | | 1050 | | 1050 | |
| Wheat gluten | 165 | | 165 | | 165 | |
| (Krõner) | | | | | | |
| Psyllium | 10 | | 10 | | 10 | |
| Germe | 24.8 | | 24.8 | | 24.8 | |
| Rapeseed oil | 15 | | 15 | | 15 | |
| Yeast | 40 | | 40 | | 40 | |
| Salt | 25 | | 25 | | 25 | |
| Sugar | 12 | | 12 | | 12 | |
| Ascorbic acid | 0.1 | | 0.1 | | 0.1 | |
| Diastase Malt | — | | 38.55 | | — | |
| Fungamyl | | | | | 0.07 | |
| Water (22° C.) | 810 | | 810 | | 810 | |
| Kneading time | 2 + 9 | | 2 + 9 | | 2 + 9 | |
| Dough rest | 15 | minutes | 15 | minutes | 15 | minutes |
| Weighing in | 650 | | 650 | | 650 | |
| (g) | | | | | | |
| Fermentation | 40 | min | 40 | min | 40 | min |
| time | | | | | | |

| | | | |
|---|---|---|---|
| Volume (ml) | 1790 | 1800 | 1890 |

The doughs showed almost no differences in their properties.

In the baked goods, in the baking test, differences could be detected depending on the additives. Bread produced with diastatic malt showed a stronger browning, but no increase in volume compared to bread produced with ascorbic acid alone. The breads without ascorbic acid showed a comparable volume (not shown in the experiment).

Through the use of α amylase, an increase in the pastry volume of approx. 100 ml could be achieved. The biscuits did not appear more strongly browned.

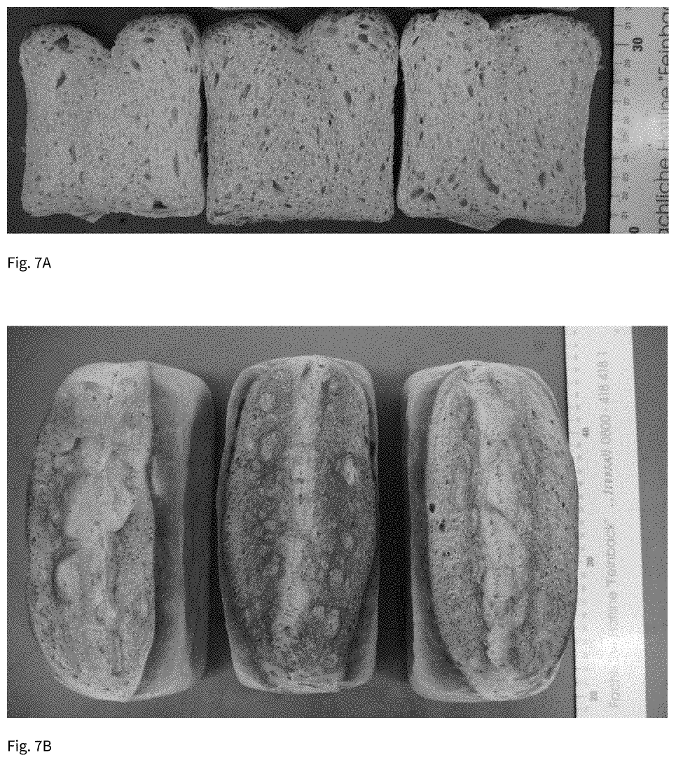

FIGS. 7A and 7B show the results of the baking tests (from left to right): ascorbic acid, diastase malt and ascorbic acid, a amylase and ascorbic acid.

### Example 7: Standardization of an ATI-Reduced Formulation

TABLE 10
Test formulation #14

| Ingredient | Quantity (g) | % share in baking mix |
|---|---|---|
| Wheat starch | 1050 | 81.3 |
| Wheat gluten A | 165 | 12.8 |
| Psyllium | 37.5 | 2.9 |
| Germe | 22.5 | 1.7 |
| Rapeseed oil | 15 | 1.2 |
| Yeast | 60 | |
| Salt | 37.5 | |
| Water | 830 | |
| Dough temp. (° C.) | 26 | |
| Kneading time (min) | 2 + 7 | |
| Fermentation time | 40 | |
| (min) | | |
| Processing/Form | Split roll | |

### Dough Properties:

The dough yield was slightly increased with TA 164 compared to typical wheat doughs. The kneading time was slightly longer than with conventional wheat doughs. During processing, clear differences in the dough properties became apparent. The surface of the doughs appeared very “dry” and the doughs were more plastic than elastic, which can be attributed to the psyllium used.

The dough was processed as cut rolls, this processing was almost impossible. No acceptable conclusion could be reached with the dough pieces. This jumped up, which is due to the dry dough characteristics. During the cooking process there was only a very slight increase in volume.

### Baking Properties:

The poor gas retention of the dough pieces during cooking resulted in baked goods with a very small volume. Despite the low volume, the cut of the rolls had a very pronounced effect. In addition, there was no typical browning of the baked goods during baking. The baked goods appeared greyish and showed an uneven “leathery” surface. The surface and crumb also appeared “stippled”, which can also be attributed to the psyllium.

For further experiments, the amount of psyllium was significantly reduced, as it has a significant influence on the dough and baking properties. The properties seem to be dominant in relation to the gluten properties.

TABLE 11

| | Test recipe | | | | | |
|---|---|---|---|---|---|---|
| | #15 | | #16 | | #17 | |
| | Quantity (g) | | Quantity (g) | | Quantity (g) | |
| Ingredient | Share | % er | Share | % er | share | % |
| Wheat starch | 1050 | 87.14 | 1050 | 83.1 | 1050 | 83.1 |
| Wheat gluten | 80 | 6.6 | 165 | 13.1 | 165 | 13.1 |
| Psyllium | 37.5 | 3.1 | 10 | 0.8 | 10 | 0.8 |
| Germe | 22.5 | 1.9 | 22.5 | 1.8 | 22.5 | 1.8 |
| Rapeseed oil | 15 | 1.2 | 15 | 1.2 | 15 | 1.2 |
| Yeast | 60 | | 60 | | 60 | |
| Salt | 37.5 | | 37.5 | | 37.5 | |
| Water | 930 | | 880 | | 850 | |
| Sugar | — | | — | | 11 | |
| Dough temp. (° C.) | 26 | | 26 | | 26 | |
| Kneading time (min) | 2 + 8 | | 2 + 8 | | 2 + 9 | |
| Fermentation time | 35 | | 35 | | 35 | |
| (min) | | | | | | |

| | | | |
|---|---|---|---|
| Refurbishment/form | Loaf pan and free | Loaf pan and free | Loaf pan and free |

### Experimental Formulation 15

The dough and baking properties were comparable with those of test recipe 14. This confirmed the impression that if the psyllium dosage is too high, the properties of this hydrocolloid predominate and no viscoelastic properties are produced.

### Experimental Formulation 16

The dough properties were comparable to those of a wheat dough. The chosen dough yield of TA 169 was high, the doughs were very soft for processing. The doughs were comparable to conventional breads with regard to crumb structure and formation of crumbs. The atypical greyish crust colour was clearly noticeable.

### Experimental Formulation 17

The dough yield (TA 167) and the kneading time were adjusted, resulting in dough properties that are typical of conventional wheat doughs. As a result of this and the use of sugar, the volume, texture, crumb structure and colour of the crust were improved to such an extent that there is almost no difference to conventional wheat bread.

### Tasting

In taste tastings, it was determined how the rolls and breads produced with trial mix 17 (mixture according to the invention) and trial mix 1 (wheat flour) affected 14 testers in comparison. The optical impression (colouring and appearance), odour and aroma, taste as well as texture and haptics were evaluated.

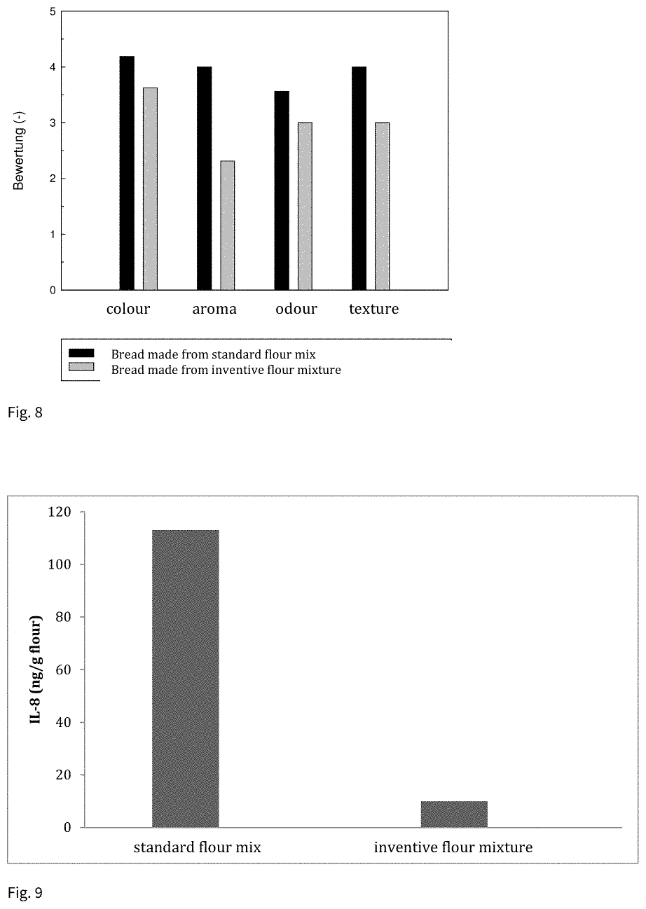

The result (FIG. 8) shows that although the testers gave different evaluations and differences could be perceived, particularly with regard to taste, the overall impression is that the products made from standard flour or the ATI-reduced flour mixture are highly similar and comparable in terms of feel, texture, colour and appearance.

### Example 8: ATI-BIOACTIVITY Determination for Test Formulations

The ATI bioactivity of test recipe 17 (flour mixture according to invention) and test recipe 1 (commercial wheat flour) was compared with the method Junker et al., 2012 (JEM, 2012) and e.g. described in WO2017075456.

For this purpose the bioactivity of ATIs is tested on human monocytes, e.g. the THP-1 cell line. Confluently grown THP-1 cells are stimulated with flour mixture extraction dissolved in neutral buffer. Depending on the amount of ATI, IL-8 is released from this cell line into the supernatant, which is then determined by a standardized ELISA according to the manufacturer's (ThermoFischer scientific) specifications.

Interestingly, clearly different cytokine releases were found in the supernatant of test cells, indicating different bioactivity of the contained ATIs.

FIG. 9 shows the result of the IL-8 specific ELISA assay, for which suitable test cells, namely ATI-reactive cells—according to WO2017075456 e.g. TLR4-expressing cells, preferably TLR4-expressing monocytes—are brought into contact with ATI extracts (buffer extraction) and then the cytokine release, namely an IL-8 release, is measured in the supernatant by ELISA. FIG. 9 shows that the flour mixture according to the invention triggers a significantly lower (more than 90% lower) IL-8 release in the ATI bioactivity test compared to a commercial standard flour.

From these data, it can be clearly concluded that patients who are ATI-sensitive and who show various NCGS symptoms can expect a significantly better tolerance and digestibility of products made from the flour mixture according to the invention.

### Example 9: Differentiated ATI Determination

For test recipe 17 (flour mixture according to invention—black bar) and test recipe 1 (commercial standard flour—white bar), a differentiated ATI determination was carried out using LC-MS/MS in accordance with Prandi et al. (Food Chemistry, 2013, 141-146).

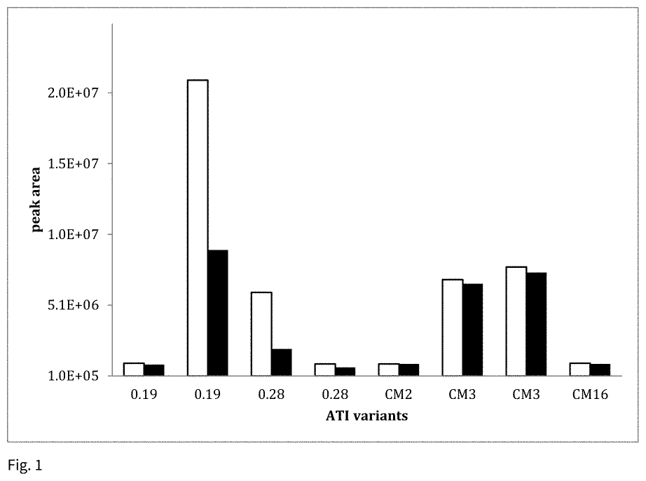

For this purpose, peptides derived from enzymatic cleavage of the salt-soluble extracts were identified using the LC-MS/MS method. Lead peptides for ATI quantification are the ATI 0.19, 0.28 and CM3 with 2 cleavage peptides each, and the ATI CM2, and CM16 with one cleavage peptide. All measurements were performed at least in duplicate determinations. FIG. 1 shows the results.

As can be seen in FIG. 1, the flour mixture according to the invention has a much lower content of ATI 0.19 and ATI 0.28 in contrast to the standard flour, while the ATI CM3 content and the ATI CM2 and CM16 content remain unchanged. The Y-axis in FIG. 1 describes the area of the peaks determined by chromatography. It is generally known to the expert that the (peak) area is proportional to the concentration of the analyte (in our case the different ATI proteins).

The inventors were thus able to show that their experimental mixture 17, for which a reduced ATI bioactivity was found, surprisingly mainly reduced the content of ATI 0.19 and ATI 0.28, while the other ATs showed smaller differences.

### Example 10: Sugar Determination According to AOAC Method (997.08)

For test recipe 17 (flour mixture according to the invention and test recipe 1 (commercial standard flour) a total sugar determination was carried out using the standard method AOAC method (997.08).

| sugar | Commercial | Flour mixture according |
|---|---|---|
| substance (g/100 g) | wheat flour | to the invention |
| Glucose (g/100 g) | <0.1 | <0.1 |
| Fructose | <0.1 | <0.1 |
| Sucrose | 0.3 | <0.1 |
| Fructooligosaccharides | 1.0 | 0.1 |

1. A flour mixture comprising one or more alpha-amylase/trypsin inhibitor (ATI)-reduced protein sources, one or more isolated ATI-reduced starch sources, one or more baking additives and, optionally one or more hydrocolloids, wherein the content of ATI 0.19 and/or the content of ATI 0.28 of the flour mixture is reduced by at least 40% compared to type 550 flour, wherein at least one protein source comprises cereal gluten protein, isolated wheat gluten, isolated gluten variants of spelt, rye, barley, emmer, oats, einkorn, or isolated gluten components or mixtures thereof and, wherein the one or more baking additives comprise sourdough, sourdough concentrate and/or dried sourdough.

2-15. (canceled)

16. The flour mixture according to claim 1, wherein the flour mixture comprises 5-25% by weight of gluten proteins.

17. The flour mixture according to claim 1, wherein the one or more starch sources comprise wheat starch, soft wheat starch or durum wheat starch.

18. The flour mixture according to claim 17, wherein the one or more starch sources is a mixture comprising wheat starch and corn starch, potato starch, tapioca starch, hydrolyzed starch, rye starch, oat starch, or barley starch or mixtures thereof.

19. The flour mixture according to claim 1, wherein the flour mixture comprises 50-95% by weight of starch.

20. The flour mixture according to claim 1, wherein the flour mixture comprises psyllium, guar gum, chia seed flour, linseed flour, xanthan gum, tragacanth, konjac, gum arabic, karaya, HPMC (hydroxy-propyl-methyl cellulose), or sunflower seed flour or mixtures thereof.

21. The flour mixture according to claim 1, wherein the flour mixture comprises up to 3% by weight of hydrocolloids.

22. The flour mixture according to claim 1, wherein an ATI extraction of the flour mixture has a bioactivity corresponding to an IL-8 release of 8 to 60 ng IL-8 per gram of the mixture and is detectable in an IL-8 specific ELISA assay.

23. The flour mixture according to claim 1, wherein the flour mixture further comprises leavening agents and yeast.

24. The flour mixture according to claim 23, wherein the flour mixture comprises Candida milleri, Candida humilis or Kazachstania milleri and/or mixtures thereof; and optionally L. pontis, L. sanfranciscensis or L. reuteri or mixtures thereof.

25. The flour mixture according to claim 23, further comprising fermentable oligo-, di-, monosaccharides or polyols or mixtures thereof.

26. A process for preparing the flour mixture according to claim 1, comprising:
a. mixing the flour mixture of claim 1 with a sourdough or a sourdough starter comprising Candida milleri, Candida humilis, Kazachstania milleri, Kazachstania exigua, Debaryomyces hansenii, Dekkera bruxellensis, Kazachstania unispora, Kluyveromyces lactis, Torulaspora delbrueckii, T. pretoriensis, Wickerhamomyces anomalus, Pichia anomala, Hansenula anomala, Pichia kudriavzevii, Issatschenkia orientalis, or Candida krusei or mixtures thereof; and optionally L. pontis, L. sanfranciscensis or L. reuteri or mixtures thereof; and
b. fermenting the product generated by step a.

27. A pasta comprising the flour mixture according to claim 1, water and/or milk, and optionally egg, egg white, egg yolk or ready-made egg, wherein the total ATI content is reduced by at least 40% compared to pasta produced from type 550 flour.

28. A bakery product comprising the flour mixture according to claim 1, wherein said bakery product comprises leavening agents, yeast, sugar, salt, bread spices, gluten-free cereals and/or pseudo-cereals as grains and/or ground and water, wherein the total ATI content is reduced by at least 40% compared to bakery products produced from type 550 flour.
